(19) United States
(12) Patent Application Publication
(10) Pub. No.: US 2024/0025696 A1
(43) Pub. Date: Jan. 25, 2024

(54) APPARATUS FOR WINDING AND PULLING A ROPE LINE AT CONSTANT SPEED

(71) Applicant: White's Welding, LLC, Woodward, OK (US)

(72) Inventors: Robert John Princess, Woodward, OK (US); Russell Thompson, Woodward, OK (US)

(21) Appl. No.: 18/374,940

(22) Filed: Sep. 29, 2023

Related U.S. Application Data
(63) Continuation-in-part of application No. 18/099,162, filed on Jan. 19, 2023.
(60) Provisional application No. 63/301,262, filed on Jan. 20, 2022.

(51) Int. Cl. B65H 54/44; B65H 54/28

(52) U.S. Cl. CPC B65H 54/44; B65H 54/283; B65H 2513/10; B65H 2557/264; B65H 2701/35

(57) ABSTRACT

A rope pulling apparatus including a drum for having rope wound therearound and a drive apparatus for providing power to the rope pulling apparatus and driving the drum's rotations. The rope pulling apparatus also includes a speed control apparatus monitoring the rope being pulled and wound on the drum and a controller for determining the speed of the rope and adjusting the drive apparatus to speed up or slow down the rotation of the drum responsive to the speed of the rope. A method of winding rope on a drum at a constant rope speed. The method includes winding a rope at a desired constant rope speed onto a drum with a rope pulling apparatus and determining a speed of the rope. The method also includes adjusting power of the rope pulling apparatus to achieve the desired constant speed.

### STATEMENT REGARDING FEDERALLY SPONSORED RESEARCH OR DEVELOPMENT

Not applicable.

### CROSS-REFERENCE TO RELATED APPLICATIONS

The present application is a continuation-in-part of U.S. patent application having U.S. Ser. No. 18/099,162, filed Jan. 19, 2023, which is a conversion of U.S. Provisional Application having U.S. Ser. No. 63/301,262, filed Jan. 20, 2022, which claims the benefit under 35 U.S.C. 119(e). The disclosure of which is hereby expressly incorporated herein by reference.

### BACKGROUND OF THE DISCLOSURE

### 1. Field of the Invention

The present disclosure relates to a rope pulling apparatus for winding and pulling a rope line at a constant speed.

### 2. Description of the Related Art

Drum pullers are used to wind rope used to pull electric lines to desired locations. For safety reasons, the electric lines can only be pulled at a certain maximum speed, thus the rope can only be pulled at the certain maximum speed. Typically, the drums the rope is wound around are turned at a constant speed such that when the rope is at the outer edges of the winding, the speed of the rope and electric line do not exceed the maximum allowed speed. The problem that occurs with the drum running at constant speed is when there is very little rope on the drum, the rope speed is very slow because not much rope length is wound per revolution of the drum.

Accordingly, there is a need for an apparatus that can pull and wind the rope at a constant speed of the rope.

### SUMMARY OF THE DISCLOSURE

The present disclosure is directed toward a rope pulling apparatus including a drum for having rope wound therearound and a drive apparatus for providing power to the rope pulling apparatus and driving the drum's rotations. The rope pulling apparatus also includes a speed control apparatus monitoring the rope being pulled and wound on the drum and a controller for determining the speed of the rope and adjusting the drive apparatus to speed up or slow down the rotation of the drum responsive to the speed of the rope.

The present disclosure is also directed toward a method of winding rope on a drum at a constant rope speed. The method includes winding a rope at a desired constant rope speed onto a drum with a rope pulling apparatus and determining a speed of the rope. The method also includes adjusting power of the rope pulling apparatus to achieve the desired constant speed.

### BRIEF DESCRIPTION OF THE DRAWINGS

FIG. 1 is a perspective view of rope pulling apparatus constructed in accordance with the present disclosure.

FIG. 2 is another perspective view of the rope pulling apparatus constructed in accordance with the present disclosure.

FIG. 3 is a perspective view of a part of the rope pulling apparatus constructed in accordance with the present disclosure.

FIG. 4 is a perspective view of another portion of the rope pulling apparatus constructed in accordance with the present disclosure.

FIG. 5 is a perspective view of another portion of the rope pulling apparatus constructed in accordance with the present disclosure.

FIG. 6 is a perspective view of another embodiment of the rope pulling apparatus constructed in accordance with the present disclosure.

FIGS. 7A and 7B are perspective views of parts of the rope pulling apparatus shown in FIG. 6 and constructed in accordance with the present disclosure.

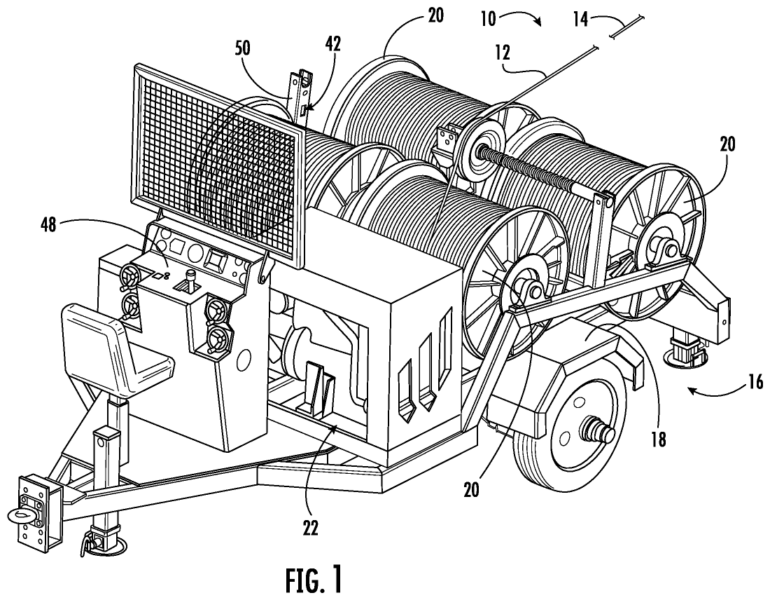

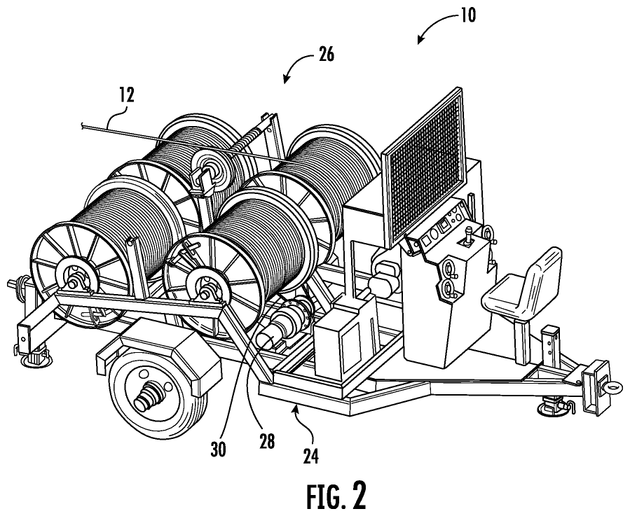

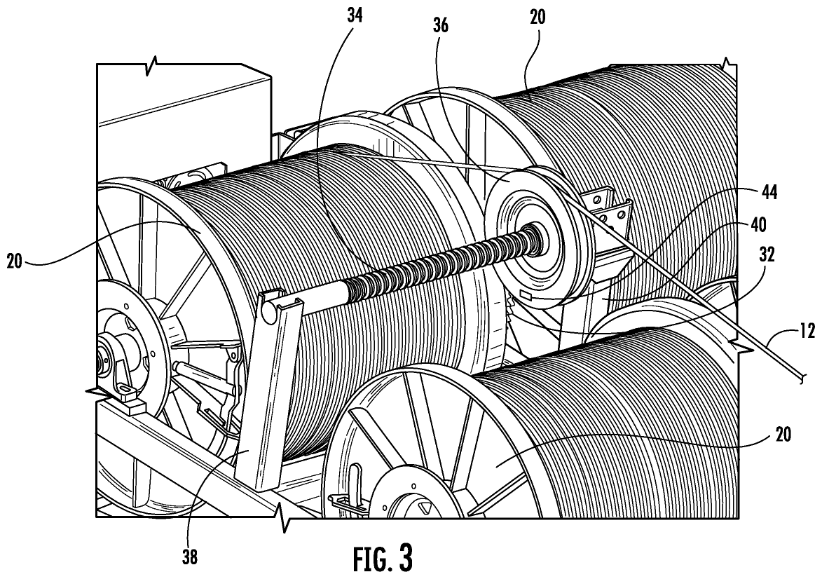

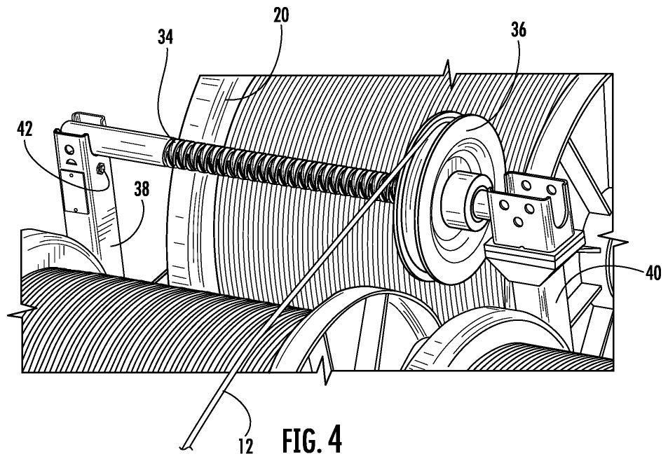

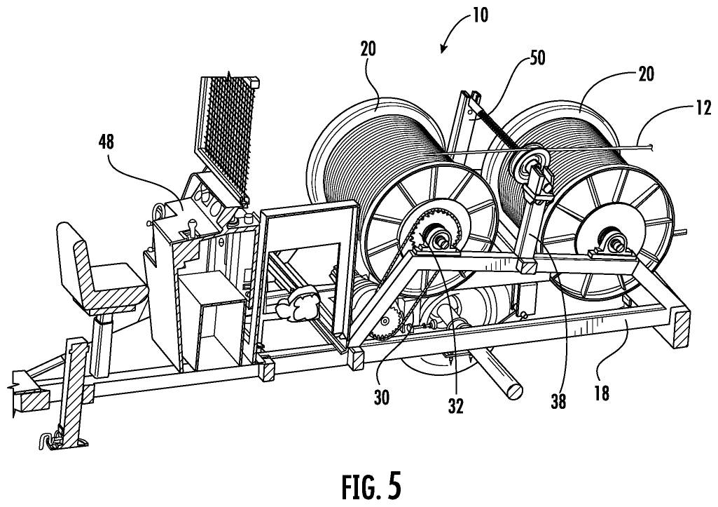

### DETAILED DESCRIPTION OF THE DISCLOSURE

The present disclosure is related to a rope pulling apparatus 10 for pulling and winding a rope 12 used to pull an electric line 14 in a desired place. The rope pulling apparatus 10 can be mounted to a transportation apparatus 16, such as a trailer or vehicle 18. The rope pulling apparatus 10 can include a drum 20 to be rotated have the rope 12 rotated thereon, an engine 22 for supplying power to the rope pulling apparatus 10, a drive apparatus 24 for transferring power from the engine 22 to the drum 20, and a speed control apparatus 26 to monitor the speed of the rope 12 being wound on the drum 20. The rope pulling apparatus 10 can include multiple drums 20 for winding multiple separate ropes 12.

The drive apparatus 24 can include any devices needed to transfer the power from the engine 22 to the drum 20. The drive apparatus 24 can include a motor 28 that turns a chain 30. The drive apparatus 24 can also include a gear 32 or sprocket 32 attached to the drum 20 that can be turned by the chain 30 being moved by the motor 28. In the situation where the rope pulling apparatus 10 has multiple drums 20, each drum 20 could have a separate gear/sprocket 32 that is connected by the same chain 30. Each drum 20 could have a clutch (not shown) that would permit a user the ability to activate the desired drum 20. Any other configuration could be established where only one drum 20 is turned at a time by the driving apparatus 24 and the engine 22.

The speed control apparatus 26 can include a self-reversing screw 34 with a sheave 36 that turns around the self-reversing screw 34. The rope 12 that is wound on the drum 20 travels across the sheave 36 and turns the sheave 36 as the rope 12 is wound. As the sheave 36 turns it travels back and forth on the self-reversing screw 34, which permits the rope 12 to be evenly wound on the drum 20. The self-reversing screw 34 can be pivotably attached on one end to a support post 38. In another embodiment, the self-reversing screw 34 can just be secured to the first support post 38. The self-reversing screw 34 can be selectively supported on the other end by a second support post 40. The speed the rope 12 is pulled is relative to the rate at which the sheave 36 rotates and the size of the sheave 36. The second support post 40 can have a sensor 42 disposed therein that works with a sensing element 44 (such as a reflector) disposed on the side 46 of the sheave 36 that is in line with the first sensor 42. When the sheave 36 turns, the sensing element 44 is detected by the first sensor 42. Each detection of the sensing element 44 corresponds to a full turn of the sheave 36, which corresponds to a certain length of rope. The rate the detections occur and the length of rope associated with each turn of the sheave 36 provides a speed of the rope 12. One example of a sensor 42 that can be used for this application is a retro-reflective sensor. It should be understood and appreciated that the sensor 42 can be disposed in any support post such that it is in line of sight with the sensing element 44 disposed on the sheave 36. The sheave 36 could have a sensing element 44 disposed on both sides so that multiple sensors located at various spots could be used to determine the rotational speed of the sheave 36.

The information from the sensor can be sent to a controller 48 of the rope pulling apparatus 10 where a speed of the rope 12 can be generated. A target speed of the rope 12 can be input into the controller 48. The controller 48 can continuously monitor the speed of the rope 12 and can increase or decrease the power of the engine 22 to cause the drum 20 to turn at a rate that corresponds to the desired speed of the rope 12. This functionality permits the rope pulling apparatus 10 to achieve a continuous rate of speed of the rope 12 being wound on the drum 20. The controller 48 can also set a range of speeds that the rope pulling apparatus 10 could operate in. For example, the controller 48 could be given low end speed that the rope pulling apparatus should not let the rope speed fall under, and it could be given an upper limit speed that the rope pulling apparatus 10 should not let the rope speed go above the upper limit speed. The controller 48 can manipulate the function of hydraulic fluid flow rate, hydraulic system pressure, engine horsepower, and rpm of the drum 20 based on the speed of the self-reversing screw 34 and sheave 36 that guides the rope 12 onto the drum 20, to maintain as close to max rated line speed as possible.

Under certain conditions, the tension on the rope 12 will spike. In this situation, the engine 22 can include a hydraulic pump swash plate that can be adjusted by the controller 48 to guard against an over horsepower event. This horsepower limiting function will keep the engine parameters within the max operating output, which will prevent any premature failures.

When multiple drums 20 are used by the rope pulling apparatus 10, the self-reversing screw 34 and sheave 36 disposed thereon can have a first position relative to a first drum 20a, a second position with respect to a second drum 20b, etc. The self-reversing screw 34 can be pivoted/rotated with respect to the first support post 38 and have the second end of the self-reversing screw 34 be supported by a third support post 50. When the self-reversing screw 34 is supported by the first support post 38 and the third support post 50, the self-reversing screw 34 would be positioned such that the sheave 36 would guide the rope 12 across the second drum 20b.

The second and third support posts 38 and 50 can include any mechanical means known in the art for securing the second end of the self-reversing screw 34 thereto. The first, second and third support posts 38, 40 and 50 can be supported by the trailer or vehicle in any manner known in the art.

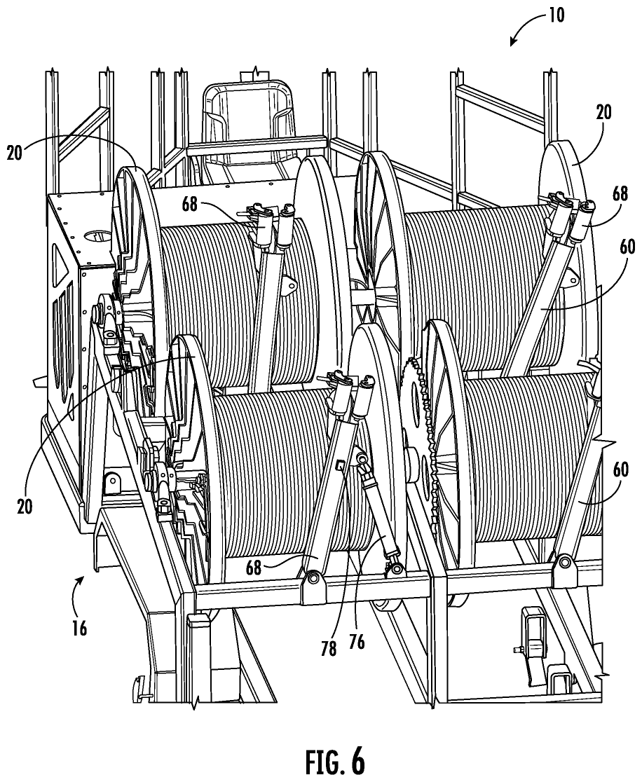

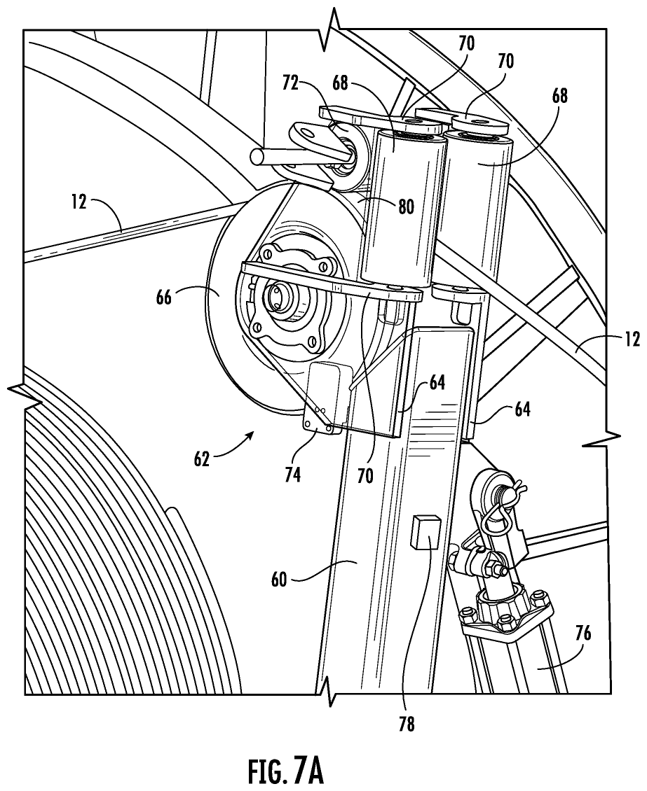

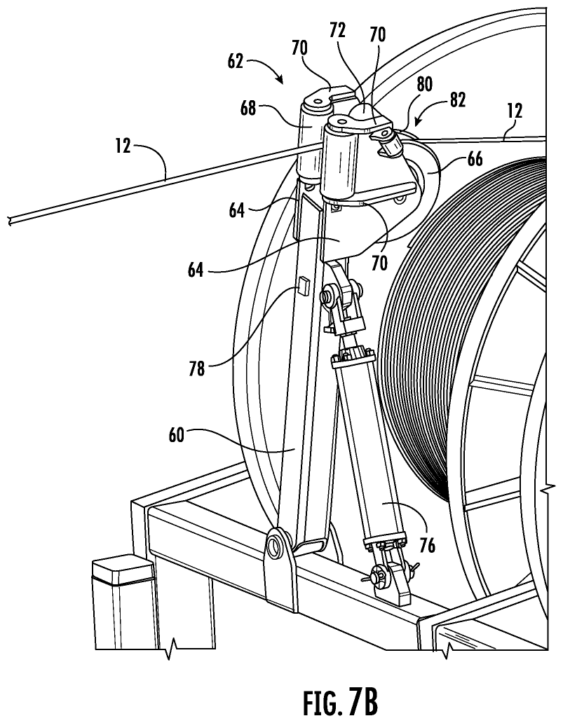

In another embodiment of the present disclosure shown in FIGS. 6-7B, the speed control apparatus 26 can include a guide post 60 that is supported by the transportation apparatus 16 of the rope pulling apparatus 10. The guide post 60 could be slidably supported by a part of the transportation apparatus 16, rotatably supported by the transportation apparatus 16, or a combination thereof. The speed control apparatus 26 can also include a guide apparatus 62 supported by the guidepost 60 to control and direct the rope 12 being wound on a particular drum 20 of the rope pulling apparatus 10. The movement of the guidepost 60 positions the guide apparatus 62 at the appropriate location laterally relative to the drum 20 as the rope 12 is being wound on the drum 20.

The guide apparatus 62 can include brackets 64 attached to the guide post 60 to rotatably support a sheave 66 that engages the rope 12 as the drum 20 of the rope pulling apparatus 10 turns and winds the rope 12 on the drum 20. The guide apparatus 62 can also include a pair of vertical rollers 68 to direct the rope 12 to the sheave 66. The vertical rollers 68 help reduce any lateral movement of the rope 12 that might affect operation of the rope pulling apparatus 10. The vertical roller 68 can be rotatable supported by slat elements 70 that extend from the brackets 64. The guide apparatus 62 can also include a horizontal roller 72 adjacent to at least a part of the sheave 66 to help maintain the rope 12 in engagement with the sheave 66 and prevent the rope from becoming disengaged with the sheave 66. Depending upon the configuration of the rope pulling apparatus 10, the horizontal roller 72 could be positioned above, below, in front of or behind the sheave 66. Similar to the vertical rollers 68, the horizontal roller 72 can be supported by flanges 74 that extend from the brackets 64. In one embodiment, the horizontal roller 72 is positioned adjacent to and on an upper side of the sheave 66. The horizontal roller 72 and channel walls 80 of the sheave 66 cooperate to keep the rope 12 in the channel 82 of the sheave 66 during operation of the rope pulling apparatus 10.

The guide apparatus 62 can also include a speed sensor 74 that determines the speed of the rope 12 passing by or determines the number of rotations of the sheave 66 per unit of time from which the speed of the rope 12 can be determined. The speed sensor 74 can be mounted to or supported by the brackets 64. It should be understood that the speed sensor 74 can be mounted to any part of the rope pulling apparatus 10 such that the speed of the rope 12 can be determined or deduced.

The movement of the guide post 60 can be manipulated by a hydraulic piston 76 that is mounted to the transportation apparatus 16 and the guide post 60. As the hydraulic piston 76 extends and contracts, the position of the guide apparatus 62 is changed relative to the drum 20. The guide post 60 can have an inclinometer 78 attached thereto to determine the angle of the guide post 60, and thus the guide apparatus 62. Based on the amount of rope 12 wound on the drum 20 and the speed of the rope 12, the guide apparatus 62 has a specific location relative to the drum 20. The inclinometer 78 provides data that can be used to determine the exact position of the guide apparatus 62 relative to the drum 20. The guide apparatus 62 has a specific location relative to the drum 20 based upon the reading of the inclinometer 78. The transportation apparatus 16 could include a second inclinometer for the trailer or vehicle 18 to provide the position of the transportation apparatus 16 relative to level when winding rope 12 on the drum 20. It should be understood and appreciated that each drum 20 that the rope pulling apparatus 10 has could have a separate and independent speed control apparatus 26.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A rope pulling apparatus, the apparatus comprising:
a drum for having rope wound therearound;
a drive apparatus for providing power to the rope pulling apparatus and driving the drum's rotations;
a speed control apparatus monitoring the rope being pulled and wound on the drum; and
a controller for determining the speed of the rope and adjusting the drive apparatus to speed up or slow down the rotation of the drum responsive to the speed of the rope.

2. The apparatus of claim 1 wherein the speed control apparatus includes a guide post supported by the rope pulling apparatus and a guide apparatus supported by the guide post, the guide apparatus guides the rope as the rope is wound on the drum.

3. The apparatus of claim 2 wherein the guide post is hingedly supported by the rope pulling apparatus to position the guide apparatus at a desired position relative to the drum to properly wrap the rope around the drum.

4. The apparatus of claim 2 wherein the guide post includes an inclinometer disposed thereon to determine the position of the guide post and the guide apparatus relative to the drum.

5. The apparatus of claim 2 wherein the guide apparatus includes two vertically disposed rollers to guide the rope towards a sheave that turns as the rope is pulled in by the rope pulling apparatus.

6. The apparatus of claim 5 wherein the guide apparatus includes a horizontally disposed roller positioned adjacent to the sheave to maintain position of the rope in a channel of the sheave when the rope is being pulled in by the rope pulling apparatus.

7. The apparatus of claim 5 wherein the speed control apparatus includes a sensor to determine the number of revolutions of the sheave per unit of time and providing that information to the controller.

8. The apparatus of claim 6 wherein the sheave is rotatably supported by brackets and the vertically disposed rollers and the horizontally disposed roller are supported slat elements that are supported by the brackets.

9. The apparatus of claim 7 wherein the sheave includes a sensing element disposed thereon that cooperates with the sensor to determine the number of revolutions of the sheave per unit of time.

9. The apparatus of claim 7 wherein the sensor is supported by the brackets of the guide apparatus.

10. The apparatus of claim 2 wherein the guide post is moved by a hydraulic piston.

11. A method of winding rope on a drum at a constant rope speed, the method comprising:
winding a rope at a desired constant rope speed onto a drum with a rope pulling apparatus;
determining a speed of the rope; and
adjusting power of the rope pulling apparatus to achieve the desired constant speed.

12. The method of claim 11 wherein the rope pulling apparatus comprises:
a drum for having rope wound therearound;
a drive apparatus for providing power to the rope pulling apparatus and driving the drum's rotations;
a speed control apparatus monitoring the rope being pulled and wound on the drum; and
a controller for determining the speed of the rope and adjusting the drive apparatus to speed up or slow down the rotation of the drum responsive to the speed of the rope.

13. The apparatus of claim 1 wherein the speed control apparatus includes a guide post supported by the rope pulling apparatus and a guide apparatus supported by the guide post, the guide apparatus guides the rope as the rope is wound on the drum.

14. The method of claim 13 wherein the guide post is hingedly supported by the rope pulling apparatus to position the guide apparatus at a desired position relative to the drum to properly wrap the rope around the drum.

15. The method of claim 13 wherein the guide post includes an inclinometer disposed thereon to determine the position of the guide post and the guide apparatus relative to the drum.

16. The method of claim 13 wherein the guide apparatus includes two vertically disposed rollers to guide the rope towards a sheave that turns as the rope is pulled in by the rope pulling apparatus.

17. The method of claim 16 wherein the guide apparatus includes a horizontally disposed roller positioned adjacent to the sheave to maintain position of the rope in a channel of the sheave when the rope is being pulled in by the rope pulling apparatus.

18. The method of claim 16 wherein the speed control apparatus includes a sensor to determine the number of revolutions of the sheave per unit of time and providing that information to the controller.

19. The method of claim 17 wherein the sheave is rotatably supported by brackets and the vertically disposed rollers and the horizontally disposed roller are supported slat elements that are supported by the brackets.

20. The method of claim 18 wherein the sheave includes a sensing element disposed thereon that cooperates with the sensor to determine the number of revolutions of the sheave per unit of time.
